(19) United States
(12) Patent Application Publication
(10) Pub. No.: US 2023/0035974 A1
(43) Pub. Date: Feb. 2, 2023

(54) CONTROL SYSTEM AND CONTROL METHOD OF SHARING DEVICE WITH LIFTING FUNCTION

(71) Applicant: FLH Co., Ltd., Taipei (TW)

(72) Inventors: Hou-Chun LEE, Taipei (TW); Ke-Wei WANG, Taipei (TW); Kuo-Chan HUANG, Taipei (TW)

(21) Appl. No.: 17/669,849

(22) Filed: Feb. 11, 2022

(30) Foreign Application Priority Data
Jul. 29, 2021 (TW) 110127979

(51) Int. Cl. A47B 21/02; A47B 9/04; G10L 15/22

(52) U.S. Cl. CPC A47B 21/02; A47B 9/04; G10L 15/22; A47B 2021/066

(57) ABSTRACT

A control system and a control method of sharing device with liftin function are provided. The portable electronic device sends a request to the cloud server. The cloud server matches the sharing device that meets the request to the portable electronic device so that the portable electronic device have a control right over the paired sharing device. Then the portable electronic device controls lifting or other functions of the sharing device within a specific time, so as to facilitate the management of multiple sharing devices in different places.

### CROSS-REFERENCE TO RELATED APPLICATIONS

This application is based upon and claims priority under 35 U.S.C. 119 from Taiwan Patent Application No. 110127979 filed on July 29, 2021, which is hereby specifically incorporated herein by this reference thereto.

### BACKGROUND OF THE INVENTION

### 1. Field of the Invention

The present relates to a sharing device, especially to a control system and control method of the sharing device with lifting function.

### 2. Description of the Prior Arts

In the past, most of the employees work in the fixed offices. The employees work together in the premises purchased or leased by the company, which is convenient for centralized management and interactive communication. In recent years, as the industrial structure has changed, the working environment has also changed. Especially in the age of the rise of micro-entrepreneurship and the prevalence of multinational internet businesses, the non-fixed office environment gradually takes a place. There are many shared offices in the market, and users can use the office equipment in the shared offices within a certain period of time as long as they pay rent.

Generally speaking, an individual user rents one of the seats in the shared office, and uses the desk and office chair of that seat. Based on the consideration of human health, standing for a period of time at work is good for health. Thus, many shared offices begin to provide lifting tables to attract users in need to rent. However, compared with ordinary desks with no additional functions, desks with lifting functions have more access rights that need to be opened to renters to operate the lifting functions. Especially for short-term renters, if managers need to frequently go to the shared office to set permissions, or need to hire fixed personnel for management, it undoubtedly increases management costs.

To overcome the shortcomings, the present invention provides a control system and a control method of a sharing device with a lifting function to mitigate or to obviate the aforementioned problems.

### SUMMARY OF THE INVENTION

To achieve the main objective of the present invention, the present invention provides a control system and a control method of sharing device with liftin function. The portable electronic device sends a request to the cloud server. The cloud server matches the sharing device that meets the request to the portable electronic device so that the portable electronic device have a control right over the paired sharing device. Then the portable electronic device controls lifting or other functions of the sharing device within a specific time, so as to facilitate the management of multiple sharing devices in different places.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a control system of a sharing device with a lifting function in accordance with the present invention;

FIG. 2 is a block diagram of another embodiment of a control system of a sharing device with a lifting function in accordance with the present invention;

FIG. 3 is a first flow chart of the control system in FIGS. 1 and 2;

FIG. 4 is a second flow chart of the control system in FIGS. 1 and 2;

FIG. 5 is a third flow chart of the control system in FIGS. 1 and 2;

FIG. 6 is a fourth flow chart of the control system in FIGS. 1 and 2; and

FIG. 7 is a fifth flow chart of the control system in FIGS. 1 and 2.

### DETAILED DESCRIPTION OF THE EMBODIMENTS

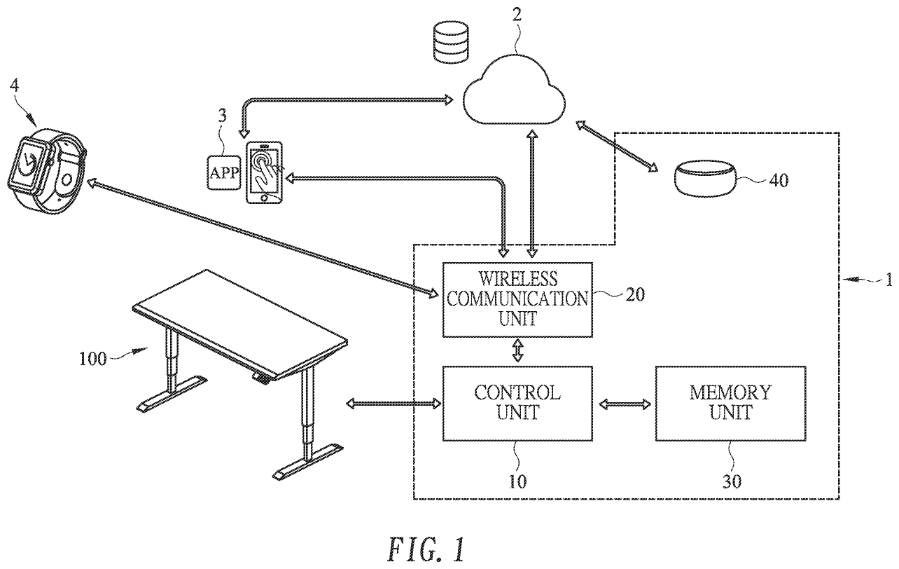

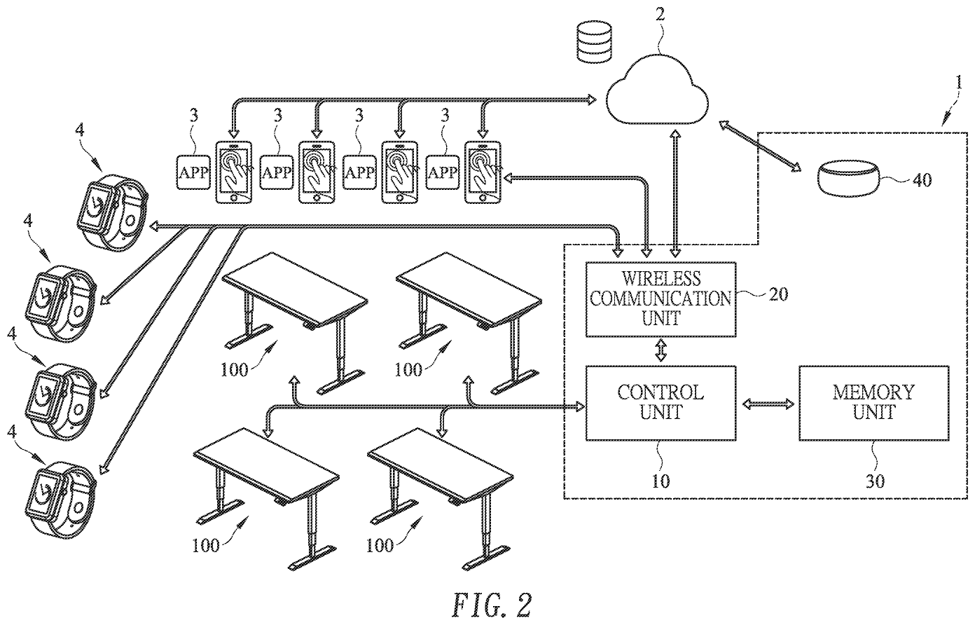

With reference to FIG. 1, a control system 1 in accordance with the present invention comprises a control unit 10, a wireless communication unit 20 and a memory unit 30. The wireless communication unit 20 and the memory unit 30 are electrically connected respectively to the control unit 10. The wireless communication unit 20 may include a Wi-Fi communication unit, or a Bluetooth communication unit, or a Near-field communication (NFC) unit, or a combination thereof. Further, the control system 1 comprises a voice control unit 40 electrically connected to the control unit 10. The voice control unit 40 may be built in the control system 1 or externally connected. The control unit 10 sends signals to and receives signals from the cloud server 2, the portable electronic device 3, and the wearable electronic device 4 through the wireless communication unit 20. The control unit 10 controls a sharing device 100 to move up and down according to control commands or to provide other peripheral functions, such as desk lights, desk sockets, horns, and drawers under desk opening and closing. In one embodiment, the control system 1 may be restricted to only transmit and receive signals from the portable electronic device 3 through a near-end connection (such as a Bluetooth communication unit or a NFC unit). The control system 1 ignores the signals sent by the portable electronic device 3 through remote connection (such as Wi-Fi). The sharing device 100 may be controlled by restricting the near-end connection, so as to avoid sending a control signal by mistake when the status of the sharing device 100 is not determined in a remote place, causing the sharing device to lift up and down to hit foreign objects or collide with others. In one embodiment as shown in FIG. 2, a control system 1 controls a plurality of the sharing devices 100, and the control system 1 may only control the sharing devices 100 through a near-end connection (such as a Bluetooth communication unit or a NFC unit).

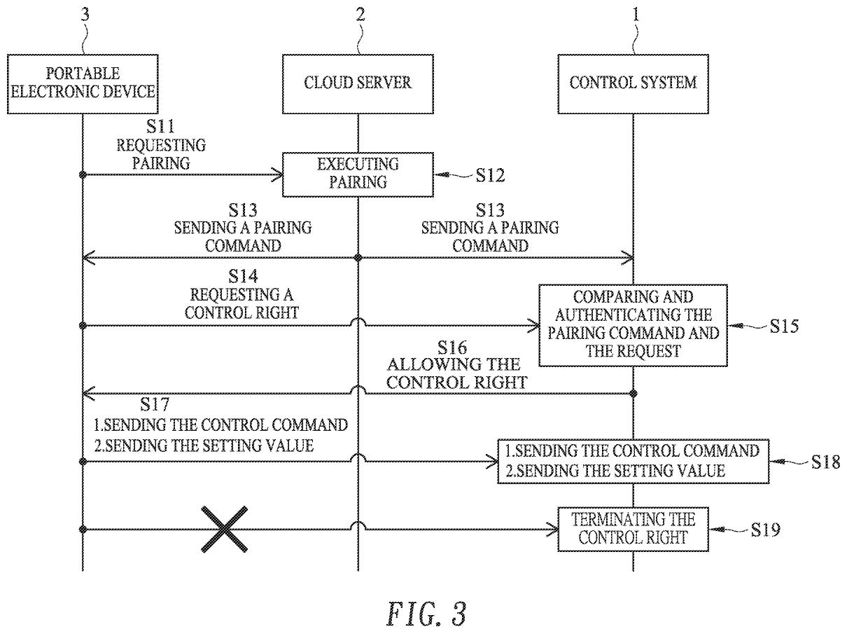

With reference to FIGS. 1 and 3, when the user requests the cloud server 2 to rent the sharing device 100 through the portable electronic device 3 (S11), the cloud server 2 performs pairing according to the request conditions made by the user (S12). The condition may be the rental time, location, functional requirements of the sharing device 100, etc. After the cloud server 2 selects an appropriate sharing device 100 for rent, the cloud server 2 sends a pairing command to the control system 1 of the selected sharing device 100 and the portable electronic device 3 that made the request (S13). Then the control unit 10 of the control system 1 of the sharing device 100 records the pairing command in the memory unit 30, and the portable electronic device 3 of the user also records the pairing command. When the user arrives near the sharing device 100, the user sends a control right request to the control system 1 of the sharing device 100 through the portable electronic device 3 (S14). The control unit 10 of the control system 1 of the sharing device 100 compares the recorded pairing command to the request, and authenticates the portable electronic device 3 as having the control right for the period of time (S15), and then the portable electronic device 3 is given a control right to control the sharing device 100 (S16). Then the control system 1 receives the control command of the portable electronic device 3 through the wireless communication unit 20 (S17). The control unit 10 operates the sharing device 100 to provide lifting or other peripheral functions(S18). When the rental time is over, or the user actively sends an interrupt command through the portable electronic device 3, or the cloud server 2 sends an interrupt command, the control system 1 terminates the control right of the portable electronic device 3 (S19). The sharing device 100 no longer controlled by the portable electronic device 3. The sharing device 100 may be controlled to further return to a preset state, such as returning to a preset height, turning off peripheral functions, and so on.

In one embodiment, the user may store may store the setting value of different lifting heights in the portable electronic device 3 for different scenario. For example, the user stores the height of the sharing device 100 required for standing, for sitting down, or for relaxing (such as dining or watching a movie) in the portable electronic device 3. When the portable electronic device 3 obtains the control right over the sharing device 100, the setting values are transmitted to the corresponding control system 1 (S17). The control system 1 stores the setting values in the memory unit 30 (S18). When the user controls the sharing device 100, the user does not need to re-enter the required height. As long as the user enters a preset command, such as standing, sitting, or relaxing, the sharing device 100 adjusts to the desired height according to the stored setting values. Thus, the users may quickly use the heights they are accustomed to use when using different sharing devices at differential times. When the control system 1 terminates the control right of the portable electronic device 3 (S19), the control system 1 deletes the aforementioned setting values and other information stored in the memory unit 30. The aforementioned setting values include not only the lifting height but also the situational functions such as the color of the desk lamp and music playback.

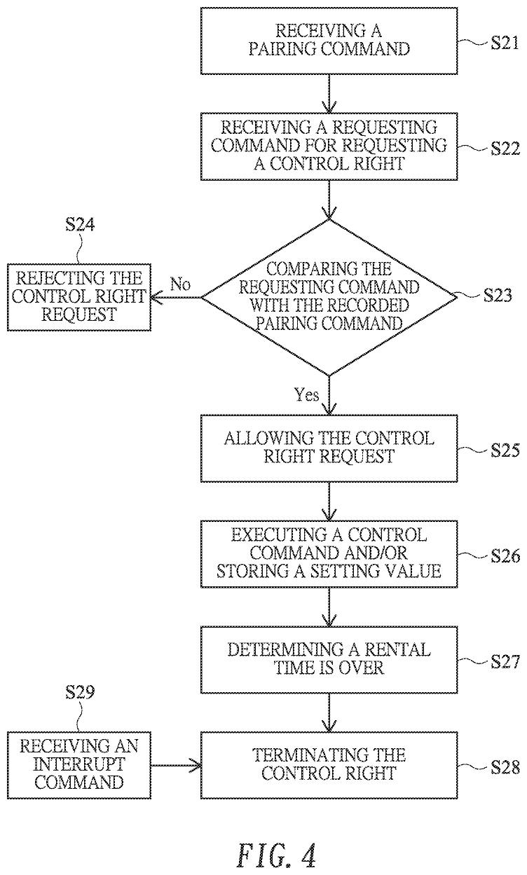

With reference to FIGS. 1 and 4, in summary, the control method executed by the control system 1 includes the following steps:

S21: Receiving and recording a pairing command from a cloud server 2 to record the information of a paired portable electronic device 3;

S22: Receiving a requesting command from a portable electronic device 3 for requesting a control right;

S23: Comparing the requesting command with the recorded pairing command;

S24: Rejecting the control right request if the requesting command does not comply with the recorded pairing command;

S25: Allowing the control right request if the requesting command complies with the recorded pairing command;

S26: Executing a control command from the portable electronic device 3, and/or storing a setting value from the portable electronic device 3

S27: Determining a rental time is over according to the recorded information of the paired portable electronic device 3; and

S28: Terminating the control right of the paired portable electronic device 3, so that the control commands from the paired portable electronic device 3 are no longer accepted, and the sharing device 100 may further return to a preset state, such as returning to a preset height, turning off peripheral functions, and so on.

In one embodiment, the cloud server 2 may issue an interrupt command to the control system 1 based on demand (S29) based on the termination request made by the user or the abnormal user fee payment. When the control system 1 receives the interrupt command from the cloud server 2 or the portable electronic device 3, the control system 1 also terminates the control right of the paired portable electronic device 3 (S28).

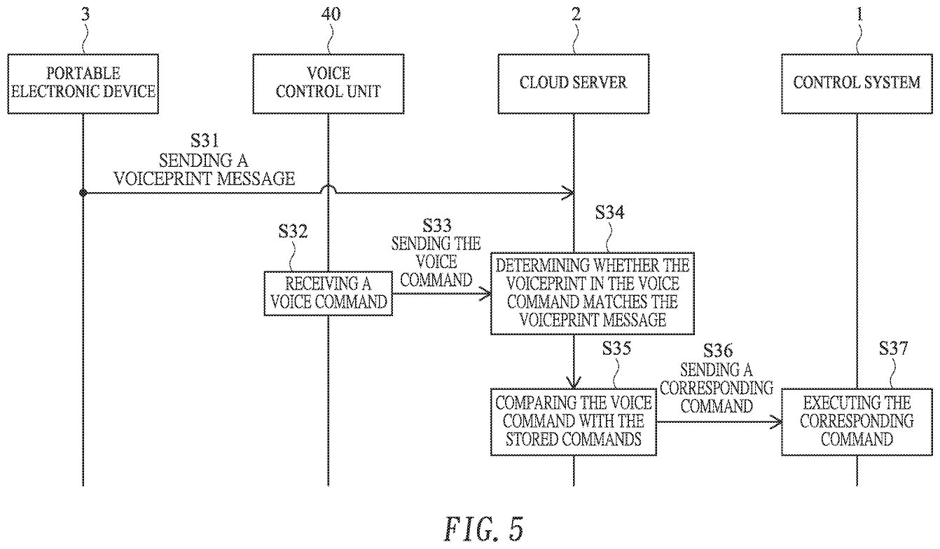

With reference to FIGS. 1 and 5, in one embodiment, the user may store voice commands in the cloud server 2 in advance, and the user may control the sharing device 100 through the voice control unit 40. When the portable electronic device 3 has received the pairing command provided by the cloud server 2, the portable electronic device 3 may send the user's voiceprint message to the cloud server 2 (S31). When the voice control unit 40 receives a voice command from the user (S32), the voice control unit 40 sends the voice command to the cloud server 2 (S33). The cloud server 2 compares whether the voiceprint in the voice command matches the voiceprint message received in step S31 (S34) to confirm whether it is indeed a voice command provided by a user who has the right to control. When the voiceprint in the voice command matches the voiceprint message received in step S31, the voice command is compared with the stored commands (S35). Then one of the stored commands corresponding to the voice command is sent to the control system 1 (S36). The control system 1 then controls the sharing device 100 to execute the corresponding stored command (S37).

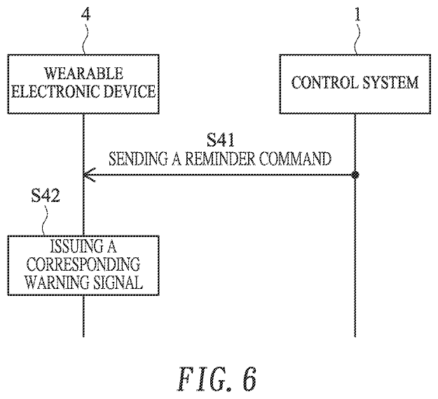

With reference to FIGS. 1 and 6, in one embodiment, a reminder instruction may be further sent to the wearable electronic device 4 paired with the portable electronic device 3 to prompt the user to stand or sit in a timely manner, so as to prevent the user from standing or sitting for a long time when using the sharing device 100. The control system 1 sends a reminder command to the wearable electronic device 4 when the sharing device 100 used maintains a height for a certain period of time (S41). After receiving the reminder command, the wearable electronic device 4 issues a corresponding warning signal (S42) to inform the user to change the standing or sitting posture in due course.

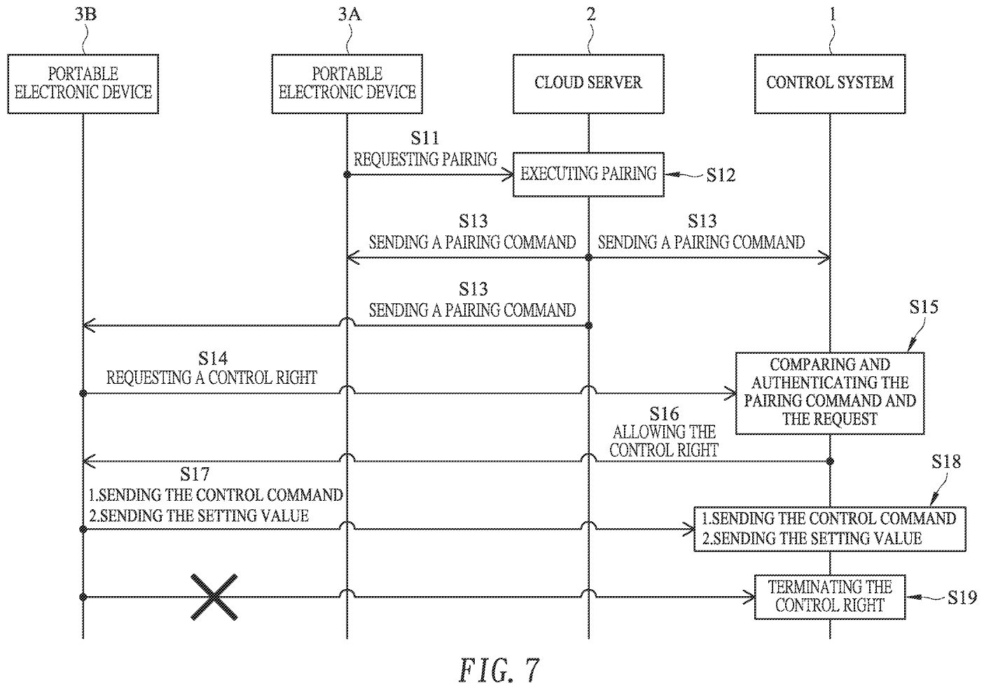

With reference to FIGS. 1 and 7, in one embodiment, a first portable electronic device 3A may rent the sharing device 100 from the cloud server 2 and assign it to a second portable electronic device 3B. It is convenient for user A to rent on behalf of user B. When the same company or workgroup needs to rent multiple sharing devices 100, the supervisor or payer may reserve multiple sharing devices 100 through a single portable electronic device and assign them to multiple portable electronic devices. The first portable electronic device 3A sends a pairing request command to the cloud server 2 (S11), which also informs the information of the second portable electronic device 3B to be designated for use. After the cloud server 2 pairs the second portable electronic device 3B (S12), it sends a pairing instruction to the first portable electronic device 3A, the second portable electronic device 3B, and the corresponding control system 1 of the sharing device 100 (S13). The subsequent control mode of the second portable electronic device 3B is the same as the foregoing description and is not to be repeated hereafter.

In one embodiment, the pairing command sent by the cloud server 2 includes the information of the corresponding portable electronic device 3, rental time, usage authority, etc. The usage authority may be determined according to the level of fees paid by the user. For example, the sharing device 100 has the lifting function, and its surroundings include desk lights, sockets, speakers, drawers, etc. When the user pays a basic fee, the user can only control the up and down of the sharing device 100. When the user pays an advanced fee, the user can obtain the control authority of the complete peripheral functions.

In one embodiment, when the control system 1 receives a control request command sent by the portable electronic device 3, the control system 1 may control the sharing device 100 to issue a warning signal (such as a warning sound, a flashing light, etc.), so that the user can quickly find the paired sharing device 100.

In conclusion, the control system 1 of the sharing device 100 receives the signal from the cloud server 2 to learn the information of the portable electronic device 3 that has the control right, so that the user obtains the control right over the sharing device 100. The owner sets the access control method of the sharing device 100 through the cloud server 2. Through the communication between the cloud server 2 and the control system 1, the control right over the specific sharing device 100 is directly granted or released to the specific portable electronic device 3, without nearby management, which helps the owner to manage multiple sharing devices 100 in different places.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A control system of a sharing device with a lifting function comprising:
a control unit;
a wireless communication unit electrically connecting to the control unit; and
a memory unit electrically connecting to the control unit, wherein the control system executes following steps:
a. the control unit receives a pairing command from a cloud server through the wireless communication unit;
b. the control unit receives a control right request from a portable electronic device;
c. the control unit determines whether the control right request complies with the pairing command; if the control right request does not comply with the pairing command, the control right request is rejected; if the control right request complies with the pairing command, the control right request is allowed;
d. the control unit executes a control command from the portable electronic device to control the sharing device, which includes lifting up or down the sharing device; and
e. the control unit terminates the control right of the portable electronic device to the sharing device when a preset time is over or an interrupt command is received.

2. The control system as claimed in claim 1, wherein the wireless communication unit includes
a remote connection unit adapted for receiving signals from the cloud server; and
a near-end connection unit adapted for receiving signals from the portable electronic device.

3. The control system as claimed in claim 1 further comprising a voice control unit electrically connecting to the control unit, wherein
when the control unit receives the pairing command from cloud server, the control unit sends a voiceprint message to the cloud server;
when the voice control unit receives a voice command, the voice control unit sends the voice command to the cloud server;
the control system receives a corresponding command to the voice command from the cloud server; and
the control unit controls the sharing device to execute the corresponding command.

4. The control system as claimed in claim 1, wherein
in the step d, the control unit stores setting values of the portable electronic device to the sharing device in the memory unit; and
in the step e, the control unit deletes the setting values from the memory unit.

5. The control system as claimed in claim 2, wherein
in the step d, the control unit stores setting values of the portable electronic device to the sharing device in the memory unit; and
in the step e, the control unit deletes the setting values from the memory unit.

6. The control system as claimed in claim 3, wherein
in the step d, the control unit stores setting values of the portable electronic device to the sharing device in the memory unit; and
in the step e, the control unit deletes the setting values from the memory unit.

7. A control method of a sharing device comprising steps of:
a. sending a pairing request command from a portable electronic device to a cloud server;
b. pairing the portable electronic device with the sharing device having a lifting function by the cloud server, and sending a pairing command to the portable electronic device and the sharing device by the cloud server;
c. sending a control right request from the portable electronic device to a control unit of the sharing device;
d. determining whether the control right request complies with the paring command by the control unit; if the control right request does not comply with the pairing command, the control right request is rejected; if the control right request complies with the pairing command, the control right request of the portable electronic device to the sharing device is allowed;
e. executing a control command from the portable electronic device by the control system, which includes lifting up or down the sharing device; and
f. terminating the control right of the portable electronic device to the sharing device when a using time is over or an interrupt command is received.

8. The control method as claimed in claim 7, wherein
the cloud server and the control unit of the sharing device communicates through a remote connection unit; and
the portable electronic device and the control unit of the sharing device communicate through a near-end connection unit.

9. The control method as claimed in claim 7 further comprising steps of:
sending a voiceprint message to the cloud server from the control unit when the control unit receives the pairing command from the cloud server;
when a voice control unit of the sharing device receives a voice command, sending the voice command to the cloud server by the control unit;
comparing the voice command with the voiceprint message by the cloud server;
sending a corresponding command to the voice command if a voiceprint in the voice command complies with the voiceprint message; and
receiving and executing the corresponding command to the voice command from the cloud server by the control unit of the sharing device.

10. The control method as claimed in claim 7, wherein the portable electronic device is paired to a wearable electronic device and the control method further comprises steps of:
sending a reminder instruction to the wearable electronic device by the control system when the sharing device maintains a height for a certain period of time; and
issuing issue a corresponding warning signal by the wearable electronic device after receiving the reminder instruction.

11. The control method as claimed in claim 7 further comprising steps of:
sending a setting value corresponding to a preset command to the control unit of the sharing device from the portable electronic device; and
adjusting the sharing device by the control unit according to the setting value when the preset command is received from the portable electronic device.

12. The control method as claimed in claim 11, wherein the setting value is a lifting height of the sharing device.

13. The control method as claimed in claim 11, wherein the control unit deletes the setting value received from the portable electronic device in the step f.

14. The control method as claimed in claim 7, wherein in the step b, the pairing command includes the using time.

15. The control method as claimed in claim 7, wherein in the step f, the control unit restores the sharing device to a preset state.

16. The control method as claimed in claim 12, wherein in the step f, the control unit restores the sharing device to a preset state.

17. The control method as claimed in claim 13, wherein in the step f, the control unit restores the sharing device to a preset state.

18. The control method as claimed in claim 15, wherein the preset state includes a lifting height of the sharing device.

19. The control method as claimed in claim 17, wherein the preset state includes a lifting height of the sharing device.

20. A control method of a sharing device comprising steps of:
a. sending a pairing request command from a first portable electronic device to a cloud server, which includes pairing a second portable electronic device to the sharing device having a lifting function;
b. pairing the second portable electronic device with the sharing device by the cloud server, and sending a pairing command to the second portable electronic device and the sharing device by the cloud server;
c. sending a control right request from the second portable electronic device to a control unit of the sharing device;
d. determining whether the control right request complies with the paring command by the control unit; if the control right request does not comply with the pairing command, the control right request is rejected; if the control right request complies with the pairing command, the control right request of the second portable electronic device to the sharing device is allowed;
e. executing a control command from the second portable electronic device by the control system, which includes lifting up or down the sharing device; and
f. terminating the control right of the second portable electronic device to the sharing device when a using time is over or an interrupt command is received.
